(19) United States
(12) Patent Application Publication
(10) Pub. No.: US 2026/0127633 A1
(43) Pub. Date: May 7, 2026

(54) SYSTEMS AND METHODS FOR OPTIMIZING ADVERTISEMENTS IN A TIERED SOFTWARE FRAMEWORK

(71) Applicant: HighLevel Inc., Dallas, TX (US)

(72) Inventors: Hardik Bhatt, Noida (IN); Karan Agarwal, Jaipur (IN); Shaun Clark, Eugene, OR (US); Robin Alex, Dallas, TX (US); Varun Vairavan, Doha (QA)

(73) Assignee: HighLevel Inc., Dallas, TX (US)

(21) Appl. No.: 18/935,862

(22) Filed: Nov. 4, 2024

(51) Int. Cl. G06Q 30/0242; G06F 18/23213; G06Q 30/0241

(52) U.S. Cl. CPC G06Q 30/0244; G06F 18/23213; G06Q 30/0246; G06Q 30/0276

(57) ABSTRACT

An application for optimizing advertisements in a tiered software framework is disclosed. The application may receive a request to optimize an advertisement. The application may predict an engagement rate of the advertisement and encode in a latent space using a machine model, an embedding from the advertisement, the latent space comprising embeddings encoded from previously published advertisements having corresponding actual engagement rates. The application may identify clusters in the latent space. The application may iteratively derive an optimized embedding based on purposeful movements in the latent space towards selected ones of the clusters, the purposeful movements being based at least on respective distances of the selected clusters from a candidate embedding derived in a preceding iteration. The application may generate a final advertisement from the optimized embedding, and publish it suitably.

### TECHNICAL FIELD

The present disclosure relates to systems, techniques, and methods directed to systems and methods for optimizing advertisements in a tiered software framework.

### BACKGROUND

Artificial intelligence (AI) is a growing field in computer science that uses machine learning models to make predictions, recommendations, or classifications based on input data. Revenue from the AI software market worldwide is expected to reach 126 billion dollars by 2025 according to some estimates. In some domains, such as marketing, AI has the potential to significantly impact the delivery of marketing services using behavioral analysis, pattern recognition, and other learning algorithms.

### BRIEF DESCRIPTION OF THE DRAWINGS

Embodiments will be readily understood by the following detailed description in conjunction with the accompanying drawings. To facilitate this description, like reference numerals designate like elements. Embodiments are illustrated by way of example, and not by way of limitation, in the figures of the accompanying drawings.

FIG. 1 is a simplified block diagram illustrating an example system for optimizing advertisements in a tiered software framework.

FIG. 2 is a simplified block diagram illustrating an example tiered software framework in an example system for optimizing advertisements.

FIG. 3 is a simplified block diagram illustrating example details of an example tiered software framework in an example system for optimizing advertisements.

FIG. 4 is a simplified diagram illustrating example details of an example system for optimizing advertisements in a tiered software framework.

FIGS. 5A-5B are simplified diagrams illustrating example details of an example system for optimizing advertisements in a tiered software framework.

FIG. 6 is a simplified block diagram illustrating example details of an example system for optimizing advertisements in a tiered software framework.

FIG. 7 is a simplified diagram illustrating example details of an example system for optimizing advertisements in a tiered software framework.

FIG. 8 is a simplified flow diagram illustrating example operations associated with an example method for optimizing advertisements in a tiered software framework.

FIGS. 9A-9B are simplified flow diagrams illustrating example operations associated with an example method for optimizing advertisements in a tiered software framework.

FIG. 10 is a simplified flow diagram illustrating example operations associated with an example method for optimizing advertisements in a tiered software framework.

### DETAILED DESCRIPTION

### Overview

For purposes of illustrating the embodiments described herein, it is important to understand certain terminology and operations of technology networks. The following foundational information may be viewed as a basis from which the present disclosure may be properly explained. Such information is offered for purposes of explanation only and, accordingly, should not be construed in any way to limit the broad scope of the present disclosure and its potential applications.

Modern technological advancements in AI have enhanced the efficiency of some manual tasks. AI uses machine learning models to make predictions, recommendations, and classifications. In general, machine learning models use algorithms to parse data, learn from the parsed data, and make informed decisions based on what has been learned. According to some classifications, deep learning models are subsets of machine learning models, being machine learning algorithms that operate in multiple layers, creating an artificial neural network. According to some other classifications, machine learning models are those that rely on human intervention to learn, whereas deep learning models automatically learn without human intervention. Because the learning algorithms are more relevant to the disclosure herein than any human intervention to provide training data, the former classification is employed herein, such that wherever “machine learning models” is used, it is intended that deep learning models are included as well.

Deep learning models, in particular, enable AI algorithms such as generative AI models (e.g., ChatGPT™). In a general sense, AI algorithms have three qualities that differentiate them from other algorithms: intentionality, intelligence, and adaptability. As intentional algorithms, they make decisions, often using real-time data, combining information from a variety of different sources, analyzing the combined information instantly, and acting on insights derived from such data. As intelligent algorithms, they are capable of spotting patterns in underlying data. As adaptable algorithms, they learn and adapt their analyses based on shifting input data.

Recent trends in AI technology include commercially available AI engines that expose application programming interfaces (APIs) for other applications to consume. In a general sense, the API is a set of rules and protocols that defines how two software systems may communicate with each other. AI APIs allow advanced AI capabilities of the AI engine to be integrated into applications by allowing the application to make requests to the API and to receive responses. Thus, these applications provide, through the API, data to the AI engine, which runs machine learning models on the data to give suitable results as requested by the applications. Different AI engines may use different machine learning models, thereby providing different results to the same input data. Some AI engines may provide a certain functionality (e.g., text processing only) and some other AI engines may provide a certain other functionality (e.g., image processing only), while some others may provide multiple functionalities (e.g., text, speech, and image processing).

An example arena where AI is being increasingly used is in marketing. With the help of AI, AI-based tools can automatically generate code, create content, and provide design recommendations for marketing campaigns based on user input. Machine learning models may be used in conjunction with search optimization techniques, such as genetic algorithms, for a variety of marketing applications. Indeed, genetic algorithms have the potential to process vast amounts of data to identify patterns and generate optimized advertisements. An advertisement typically comprises a combination of a creative (e.g., multimedia designed to capture attention), a copy (e.g., textual content), a brand kit (e.g., logos, brand colors, fonts, etc.) and a call-to-action (CTA) (e.g., interactive elements). By iteratively testing variations of the creative, copy, brand kit and CTA, genetic algorithms can yield the combination that has the highest engagement rate, such as click-through-rate (CTR).

In general, genetic algorithms work by creating populations of variants of the advertisement, each with unique “genetic” attributes representing consumer data, such as browsing history, purchase records, engagement metrics, etc. Those advertisements that achieve the highest engagement rate may be selected to pass their “genes” to the next generation of variants. Crossover techniques may be applied, for example, by combining traits of two high-performing ad variants; mutations may apply random changes to any population of variants. The process is iterative, with each iteration producing a lineage of new advertisement variants, each lineage successively better than the previous one in terms of a fitness function or metric, such as the highest CTR, impressions, visits, etc.

One technique uses genetic algorithms to automatically generate the headline and text of advertisements. This technique starts with a random advertisement (ad) skeleton from an ad skeleton corpus and uses it to produce an initial population with 100 individuals, each individual differing from the others in some manner regarding the textual content, which is populated from a prerecorded text corpus. These individuals produce another 100 offsprings that go through crossover and mutation as part of the genetic process. The mutation involves replacing a random word with another related word. The crossover involves swapping a random related word between pairs of individuals. At the end of each iteration (i.e., generation or lineage), all the 200 individuals of the parent and offspring generations are scored according to a fitness function that tests for novelty, ability to draw attention, memorability, clarity, informativeness, and distinctiveness. 100 of the fittest individuals are selected to survive into the next generation. The process is repeated for 200 generations.

Another optimization technique uses heuristic methods in combination with genetic algorithms to improve ad campaigns. This heuristic technique considers displaying the most interesting adverts for customers such that the number of visits meets the advertiser's requirements. The genetic algorithm maximizes the fitness function, which considers the interest of the user in the adverts measured as the average CTR of all predicted visits and the number of visits that matches those settings to ensure a sufficient number of visits to meet the demand of a majority of advertisers.

Yet another technique uses machine learning without genetic algorithms to optimize advertisements. This technique proposes an automated creative optimization framework for optimal selection of advertisements. The framework simultaneously models complex interaction between creative elements and strikes a balance between exploration and exploitation. The advertisement is modeled as a composite of creative elements, namely a template, picture size, text font, background blur, and background color. At the time of impression, a product sends a request to the platform, and the platform instantly selects the advertisement from multiple candidates for display. Due to the multiple elements in the composite, a combination of them can result in an exponential explosion in the number of potential advertisements. For example, given 4 templates, 10 fonts, 10 colors, and 5 picture sizes, 2,000 advertisements can be composited for one of the product images. The collection of sufficient samples for model training in such a scenario is time-consuming and expensive. Therefore, the platform reduces the advertisement to operation-aware embeddings in a latent space, each embedding being a parametric model with corresponding model weights for each parameter that vary according to the operation in the model (i.e., addition has a different weight compared to multiplication). A “multi-armed bandit” Thompson Sampling algorithm is used to search in the latent space for potential candidates that minimize cumulative regret, expressed as Kullback-Leibler (KL) divergence between the CTR of the candidate and a maximal expected CTR. The Thomson Sampling algorithm recommends a new candidate by sampling the model weights encoded in the embeddings to generate new candidates that are then evaluated for cumulative regret.

Such techniques currently in use are either computationally complex or inefficient or both. In general, they apply random selection techniques in genetic algorithms. Even where exploration and exploitation are attempted to be balanced, as in the Thompson Sampling technique, the computations are complex, mostly randomized, and potentially time consuming. Indeed, in the Thompson Sampling technique, a potential candidate is derived from a sampling of all the embeddings in the latent space, which is computationally expensive. Exploration in the Thompson Sampling technique is made efficient to a certain extent by encoding the advertisement in a specific way (i.e., with operational awareness using appropriate model weights and parameters); but otherwise, the entire latent space is potentially uniformly explorable. Such a technique is cumbersome and expensive, requiring custom embedding algorithms, preventing use of commercially or generally available embedding algorithms in the marketplace.

In contrast, according to one embodiment of a method to optimize advertisements, a deep learning model is trained on a plurality of previously published advertisements to generate corresponding embeddings in a multi-dimensional latent space. In some embodiments, the number of previously published advertisements may be more than a million. The deep learning model may be commercially available, or may be specifically developed and configured, based on particular needs. An embedding of an initial advertisement submitted by a user is generated in the latent space using the deep learning machine model. A predetermined number of clusters of embeddings, say n clusters, having high-CTR is identified in the latent space near the newly encoded embedding. A population of n variants is generated by adjusting positional offsets and scaling factors of the initial advertisement according to the parameters of the identified n clusters and corresponding CTR predicted. Then, a new set of k variants is generated by a crossover algorithm, combining positional offsets and scaling factors for individual design elements across pairs of designs from the variants having the highest CTR in the parent population. The positional offsets and scaling factors are guided by the prevalent positions and scales of design elements in the advertisements in the high CTR embeddings of the previous generation. For example, a high CTR cluster near the initial embedding has advertisements with creative elements on the left and text on the right. In such a scenario, the positional offsets and scaling of the child variants will also have design elements accordingly, with creative elements offset towards left and text element offset towards right. This process is repeated for a predetermined number of iterations, for example, 20 iterations.

According to another embodiment disclosed herein, a method for optimizing advertisements in a tiered software framework includes identifying clusters in the latent space of embeddings and iteratively deriving an optimized embedding based at least on: (i) purposeful movements in the latent space towards selected clusters, and (ii) predicted engagement rates of candidate embeddings derived from the purposeful movements. By basing the selection of candidate embeddings on purposeful movements in the latent space towards promising clusters instead of random selections covering the entire latent space as in current techniques, the iterations may converge faster with less use of computational resources as well. Moreover, the purposeful movements in various embodiments are based on relative differences in engagement rates or respective distances of the selected clusters from candidate embeddings or both derived in preceding iterations. In some embodiments, the purposeful movements may be based on gradients in engagement rates between the selected cluster and the candidate embedding.

In the following detailed description, various aspects of the illustrative implementations may be described using terms commonly employed by those skilled in the art to convey the substance of their work to others skilled in the art.

The term “connected” means a direct connection (which may be one or more of a communication, mechanical, and/or electrical connection) between the things that are connected, without any intermediary devices, while the term “coupled” means either a direct connection between the things that are connected, or an indirect connection through one or more passive or active intermediary devices.

The term “computing device” means a server, a desktop computer, a laptop computer, a smartphone, or any device with a microprocessor, such as a central processing unit (CPU), general processing unit (GPU), or other such electronic component capable of executing processes of a software algorithm (such as a software program, code, application, macro, etc.).

The term “cloud network” means a network of computing devices coupled together in a public, private, or hybrid communications network. Communication in the cloud network may use one or more wired, wireless, broadband, radio, and other kinds of communicative means. The Internet is an example of a cloud network.

As used herein, the term “application” can be inclusive of an executable file comprising instructions that can be understood and processed on a computing device such as a computer, and may further include library modules loaded during execution, object files, system files, hardware logic, software logic, or any other executable modules. Applications are generally configured to perform particular tasks, or functions according to the type of application.

As used herein, the term “advertisement” comprises a digital version of a promotional communication. The advertisement comprises at least one selected from: a creative, a copy, a CTA and a brand kit. The term “creative” refers to multimedia, such as static images (e.g., illustrations, pictures, photos, icons, backgrounds, etc.) and moving images (e.g., videos, GIFs, animations, etc.), audio, stylized text, colorized text, and such other visual and textual content that is specially tailored to capture a viewer's attention. In some instances, the creative may be more specifically described, for example, as an icon, or photo, or video, without limiting to such specific descriptions. Thus, where an icon is described, the embodiments herein contemplate that any other kind of creative may be substituted therewith without departing from the scope of the corresponding embodiment. The text in the advertisement is referred to herein as “copy.” The interactive element in the advertisement is referred to herein as “CTA”. Any brand information in the advertisement including trademarks along with their associated colors and fonts, is referred to as a “brand kit.” Some advertisements may have multiple creatives, such as background images and foreground images, or static images and animations; some advertisements may have multiple copies, such as headlines and body text; some advertisements may have multiple CTAs, such as an interactive element for liking a post and another one for subscribing to be a follower; some advertisements may have multiple brand kits, such as a company brand and a different product brand; and so on. Some other advertisements may not have all of creative, copy, CTA and brand kit. All such variations are encompassed within the broad scope of the embodiments described herein.

As used herein the term “embedding” refers to a numerical representation of an advertisement that captures inherent properties and relationships between attributes, such as color, text, placement, image values, etc. associated with the advertisement. The embeddings can be a multi-dimensional vector comprising real numbers, each number encoding an attribute of the advertisement. For example, an image is high-dimensional data when each pixel color value is considered a separate dimension; when embedded, the image is transformed into a multi-dimensional vector, each dimension representing pixel color values, or relations thereof, with the dimension having specific significance encoded thereto. In general, the embedding reduces the number of dimensions of the high-dimensional advertisement by identifying commonalities and patterns between various features, thereby reducing computing resources and time required to process raw data. Thus, the embedding of an item may use less memory space than the item. Any suitable mathematical technique for encoding the high-dimensional data in the advertisement to the low-dimensional embedding may be used in the embodiments described herein. Examples of neural architectures that can be used to create embeddings include ordinary autoencoder (AE), variational autoencoder (VAE), generative adversarial network (GAN), transformer architecture encoder, and contrastive loss network. In addition, the term “embedding” may be used interchangeably with “encoding,” “latent representation” and “latent space representation” in reference to the various embodiments without departing from the scope of the disclosure.

The description uses the phrases “in an embodiment” or “in embodiments,” which may each refer to one or more of the same or different embodiments.

The words “optimize,” “optimization,” and related terms are terms of art that refer to improvements in speed and/or efficiency of a specified outcome and do not purport to indicate that a process for achieving the specified outcome has achieved, or is capable of achieving, an “optimal” or perfectly speedy/perfectly efficient state.

Although certain elements may be referred to in the singular herein, such elements may include multiple sub-elements. For example, “a computing device” may include one or more computing devices.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

In the following detailed description, reference is made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

The accompanying drawings are not necessarily drawn to scale. In the drawings, same reference numerals refer to the same or analogous elements shown so that, unless stated otherwise, explanations of an element with a given reference numeral provided in context of one of the drawings are applicable to other drawings where element with the same reference numerals may be illustrated. Further, the singular and plural forms of the labels may be used with reference numerals to denote a single one and multiple ones respectively of the same or analogous type, species, or class of element.

Note that in the figures, various components are shown as aligned, adjacent, or physically proximate merely for ease of illustration; in actuality, some or all of them may be spatially distant from each other. In addition, there may be other components, such as routers, switches, antennas, communication devices, etc. in the networks disclosed that are not shown in the figures to prevent cluttering. Systems and networks described herein may include, in addition to the elements described, other components and services, including network management and access software, connectivity services, routing services, firewall services, load balancing services, content delivery networks, virtual private networks, etc. Further, the figures are intended to show relative arrangements of the components within their systems, and, in general, such systems may include other components that are not illustrated (e.g., various electronic components related to communications functionality, electrical connectivity, etc.).

In the drawings, a particular number and arrangement of structures and components are presented for illustrative purposes and any desired number or arrangement of such structures and components may be present in various embodiments. Further, unless otherwise specified, the structures shown in the figures may take any suitable form or shape according to various design considerations, manufacturing processes, and other criteria beyond the scope of the present disclosure.

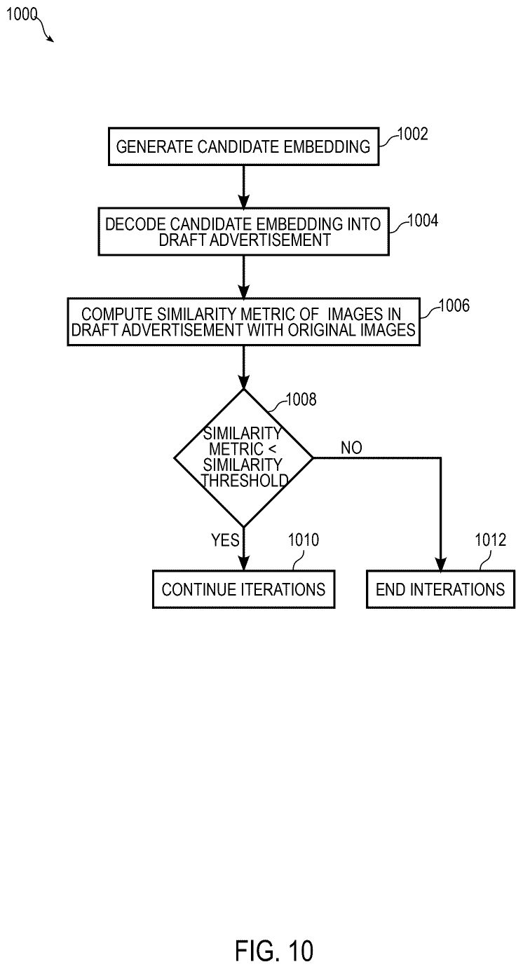

For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 106a, 106b), such a collection may be referred to herein without the letters (e.g., as “106”) and individual ones in the collection may be referred to herein with the letters. Further, labels in upper case in the figures (e.g., 106A) may be written using lower case in the description herein (e.g., 106a) and should be construed as referring to the same elements.

Various operations may be described as multiple discrete actions or operations in turn in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### EXAMPLE EMBODIMENTS

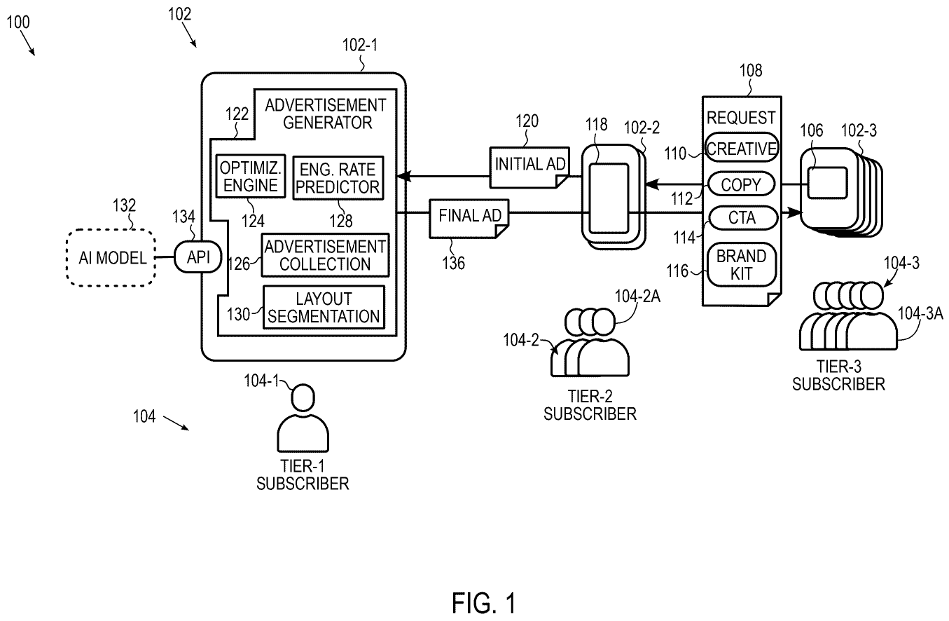

FIG. 1 is a simplified block diagram illustrating an example advertisement application 100 according to embodiments of the present disclosure. Advertisement application 100 may comprise various tiers 102. In the example shown, three tiers are shows, namely 102-1, 102-2 and 102-3. Note that the labeling convention followed herein uses the hyphen followed by a number to denote a separate tier corresponding to the number (e.g., “-1” denotes tier-1, “-2” denotes tier-2, and “-3” denotes tier-3). Tiers 102 may be accessed by subscribers 104 according to access credentials based on their respective tiers 102. For example, subscribers 104-1 may have access to tiers 102-1, 102-2, and 102-3; subscribers 104-2 may have access to tiers 102-2 and 102-3; and subscribers 104-3 may have access only to tier 102-3.

Tiers 102 may be organized according to a hierarchy of management (i.e., to oversee, to control, to maintain), with upstream tiers managing downstream ones. Thus, tier 102-1 comprises operations that may manage tiers 102-2 and 102-3, whereas tier 102-2 comprises operations that may manage tier 102-3 but not tier 102-1. For purposes of terminology, tier 102-1 is “upstream” relative to tiers 102-2 and 102-3; tier 102-3 is “downstream” relative to tiers 102-2 and 102-1; tier 102-2 is downstream relative to tier 102-1 and upstream relative to tier 102-3. In some embodiments, each tier 102 may interact with the tier immediately adjacent thereto (e.g., downstream or upstream) but not with non-adjacent tiers. In some other embodiments, any tier 102 may interact with any other tier. In an example embodiment, tier 102-3 comprises marketing activities by business locations such as a dentist's office, a plumber's business, etc. ; tier 102-2 comprises software operations by one or marketing agencies whose customers are the business locations of tier 102-3; and tier 102-1 comprises software operations by subscriber 104-1 whose customers are the marketing agencies of tier 102-2.

Advertisement application 100 may be managed by subscriber 104-1 providing one or more downstream subscribers 104-2 at tier 102-2 with access to certain functionalities of advertisement application 100. In turn, subscriber 104-2 may provide one or more downstream subscriber 104-3 at tier 102-3 with access to certain other functionalities of advertisement application 100. In various examples, the functionalities available to subscribers 104-1 may not be the same as those available to subscribers 104-2, which may be different from those available to subscribers 104-3. In one example, functionalities available to subscribers 104-3 may be a subset of functionalities available to subscribers 104-2. Subscribers 104 (e.g., 104-1, 104-2 and 104-2) may include an entity (i.e., a company, an organization, etc.) in various embodiments. In an example embodiment, subscribers 104-1 may be software-as-a-service (SaaS) providers, subscribers 104-2 may comprise marketing agencies, and subscribers 104-3 may comprise individual businesses, such as plumbers, dentists, pet stores, etc.

Human users at subscribers 104 may operate or otherwise use advertisement application 100 through one or more devices such as computers, laptops, smartphones, mobile computing devices, mobile phones, iPads™, Google Droids™, Microsoft® Surface™, etc. In various embodiments, a single subscriber 104-1 may have multiple subscribers 104-2 at tier 102-2; a single subscriber 104-2 at tier 102-2 may have multiple subscribers 104-3 at tier 102-3. Each subscriber 104-2 may have an account with one subscriber 104-1 at tier 102-1; each subscriber 104-3 may have an account with one subscriber 104-2 at tier 102-2. In other words, there may be a one-to-many relationship downstream (e.g., from tier-1 to tier-2 to tier-3), and a one-to-one relationship upstream (e.g., from tier-3 to tier-2 to tier-1).

In various embodiments, advertisement application 100 may include a requestor 106 executing in tier 102-3. Note that requestor 106 may be associated with a particular one of tier-3 subscribers 104-3, say 104-3a. Note also that the labeling convention followed herein uses letters to denote a separate instance of the same component (e.g., “a” denotes instance A, “b” denotes instance B, and so on). Other tier-3 subscribers 104-3, say 104-3b and 104-3c, may be associated with other instances of requestor 106, namely 106b and 106c, respectively. Requestor 106 may be configured to send a request 108 to a particular one of tier-2 subscribers, say 104-2a, at tier 102-2 for generating an advertisement. In some embodiments, requestor 106 may send request 108 to tier 102-2 in response to instructions from one of subscribers 104-3 at tier 102-3. For example, the particular tier-3 subscriber 104-3a may be dentistry business, and subscriber 104-2a may be a marketing agency whose customer is the dentistry business. Request 108 may be sent by a human user of subscriber 104-3a requesting subscriber 104-2a to create an advertisement for the dentistry business as part of a marketing strategy. In some examples, request 108 may be sent by clicking an appropriate button on a user interface of advertisement application 100; in other examples, request 108 may be sent via email, short message service (SMS) text messages, chat messages and/or other forms of communication within advertisement application 100, or external to advertisement application 100.

Request 108 may include at least one selection from: a creative 110, a copy 112, a CTA 114, and a brand kit 116. Creative 110 may comprise any suitable static or dynamic image, including pictures, drawings, gifs, videos, etc. ; copy 112 may comprise textual content; CTA 114 may comprise an interactive element such as a link, a button, etc. ; brand kit 116 may comprise a collection of brand elements, such as trademarks, brand colors, font specifications, etc. that is relevant for the business needs of tier-3 subscriber 104-3 sending request 108. Note that any number of creative 110, copy 112, CTA 114 and brand kit 116 may be included in request 108 without departing from the scope of the embodiments. In some embodiments, not all of creative 110, copy 112, CTA 114, and brand kit 116 may be provided in request 108. In other embodiments, at least one each of creative 110, copy 112, CTA 114, and brand kit 116 may be provided in request 108. Various such combinations are included in various example embodiments.

Request 108 may be received at tier 102-2 and forwarded to tier 102-1 after processing by forwarder 118. Forwarder 118 may arrange available ones of creative 110, copy 112, CTA 114, and brand kit 116 in request 108 into an initial advertisement 120. Note that the term “advertisement” is shortened to “ad” in the figure for ease of illustration and so as not to clutter. Wherever the term “ad” is used in the drawings and the description, such reference is to “advertisement.” Initial advertisement 120 may comprise the available ones of creative 110, copy 112, CTA 114, and brand kit 116 arranged in a tentative layout based on predetermined configurations. In some embodiments, the tentative layout may be fixed for several ones of initial advertisement 120 irrespective of the source of request 108. In other embodiments, the tentative layout may be based on the last finalized advertisement in a previous operation. In yet other embodiments, the tentative layout may be based on user provided inputs in request 108. In yet other embodiments, the tentative layout may be based on access credentials of tier-3 subscriber 104-3 who sent request 108.

Different instances of tier-2, e.g., 102-2a-102m, may comprise corresponding different instances of forwarder 118a-118m. The particular instance of forwarder 118a that receives and processes request 108 may be based on subscription associations between requester tier-3 subscriber 104-3 and tier-2 subscriber 104-2. The subscription associations may include information of subscriber 104-3 that has been previously provided to subscriber 104-2, including type of the business, name and other details of the business, geographic locations, currently ongoing deals and discounts, business category, business market niche, business size, business revenue, business marketing processes, business social media accounts, product/service descriptions, store timings, customer demographics, customer preferences, customer behavior, business trends, customer trends, and such other business information. In some embodiments, such information may be used in selecting the tentative layout of initial advertisement 120. In various examples, data associated with each tier-3 subscriber 104-3 may be segregated from data of other tier-3 subscribers 104-3 at tier 102-2. In some examples, the data may be stored at respective accounts in tier 102-3 and retrieved for temporary (e.g., transient) storage in tier 102-2 upon receiving request 108.

Forwarder 118 may forward initial advertisement 120 to an advertisement generator 122 executing in tier 102-1. In various embodiments, advertisement generator 122 may receive substantially all information contained in request 108 from forwarder 118 along with initial advertisement 120 so that request 108 may be deemed sent to advertisement generator 122. Advertisement generator 122 may include an optimization engine 124 (shortened to “OPTIMIZ. ENGINE” in the figure merely for ease of illustration), a collection of previously published advertisements in an advertisement collection 126, an evaluator 128, and a layout segmentation module 130 (shortened to remove “MODULE” merely for ease of illustration). In various embodiments, optimization engine 124 and/or evaluator 128 may interface with an AI model 132 through API 134. In some embodiments, AI model 132 may be native to advertisement generator 122 and may execute at tier 102-1. In some other embodiments, AI model 132 may be a third-party tool that may be provided to advertisement application 100 through API 134. Advertisement generator 122 may generate a final advertisement 136 from initial advertisement 120.

Final advertisement 136 may be published at tier 102-3. In some embodiments, final advertisement 136 may be sent to forwarder 118, which may publish final advertisement 136 at tier 102-3 suitably. Final advertisement 136 may be published in a social media post in an example embodiment. In another embodiment, final advertisement 136 may be published on a website. In yet another embodiment, final advertisement 136 may be published in an email sent out as part of a marketing campaign. Various other mechanisms for publishing final advertisement 136 are contemplated within the broad scope of the embodiments.

During operation, a particular tier-3 subscriber 104-3a, may submit request 108 to tier-2 subscriber 104-2a. Responsive to request 108, forwarder 118a may generate initial advertisement 120 and send to advertisement generator 122 executing in tier 102-1. Advertisement generator 122 may modify the layout of initial advertisement 120 into a pre-final advertisement based on various criteria, for example, optimized engagement rate (e.g., CTR), engagement rates of previously published advertisements in advertisement collection 126, etc. Layout segmentation module 130 may modify the pre-final advertisement into final advertisement 136 based on request 108.

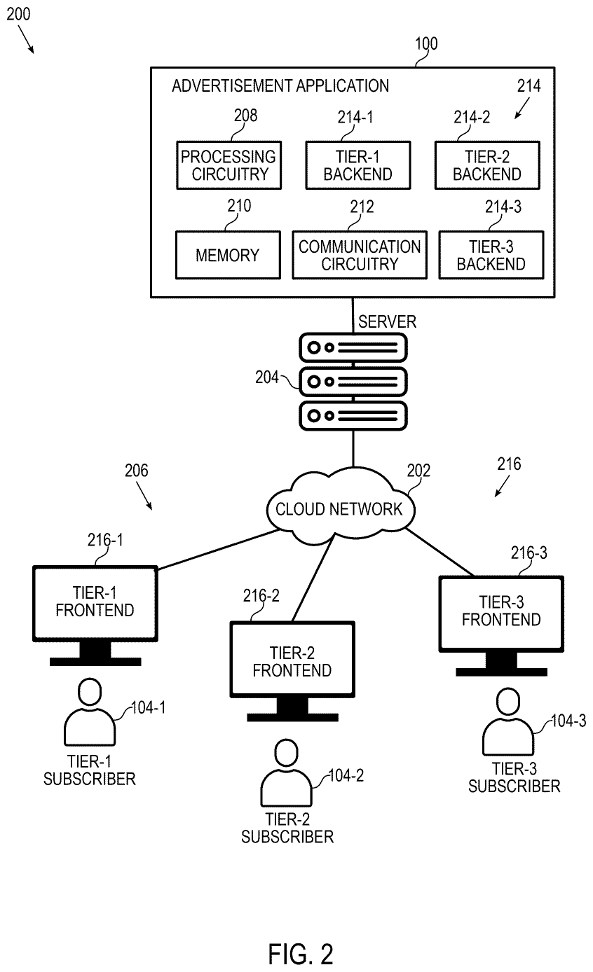

FIG. 2 is a simplified block diagram illustrating a tiered software framework 200 according to various embodiments. In example implementations, at least some portions of the activities outlined herein may be hosted on a cloud network 202 in one or more servers 204. At least some other portions of the activities outlined herein may be implemented in one or more computing devices 206 connected over one or more communication networks with cloud network 202. In particular embodiments, cloud network 202 is a collection of hardware devices and executable software forming a shared pool of configurable computing resources (e.g., networks, servers, storage, applications, services, etc.) that may be suitably provisioned to provide on-demand self-service, network access, resource pooling, elasticity and measured service, among other features. Computing device 206 may have any desired form factor, such as a handheld or mobile computing device (e.g., a cell phone, a smart phone, a mobile Internet device, a tablet computer, a laptop computer, a netbook computer, an ultra-book computer, a Personal Digital Assistant (PDA), an ultramobile personal computer, etc.), a desktop computing device, a server or other networked computing component, a set-top box, an entertainment control unit, or a wearable computing device.

Certain portions of tiered software framework 200 (e.g., advertisement application 100) may execute using a processing circuitry 208, a memory 210 and communication circuitry 212 (among other components) in one or more servers 204. Certain other portions of tiered software framework 200 may execute in one or more computing devices 206 using respective processing circuitry, memory, and communication circuitry (not shown with particularity so as not to clutter the drawing) substantially similar in functionalities to processing circuitry 208, memory 210 and communication circuitry 212. In some embodiments, one or more of these features may be implemented in hardware, provided external to these elements, or consolidated in any appropriate manner to achieve the intended functionality. The various network elements in tiered software framework 200 may include communication software that can coordinate to achieve the operations as outlined herein. In still other embodiments, these elements may include any suitable algorithms, hardware, software, components, modules, interfaces, or objects that facilitate the operations thereof.

Processing circuitry 208 may execute any type of instructions associated with data stored in memory 210 to achieve the operations detailed herein. In one example, processing circuitry 208 may transform data from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., field programmable gate array (FPGA), an erasable programmable read only memory (EPROM), an application specific integrated circuit (ASIC)) that includes digital logic, software, code, electronic instructions, flash memory, optical disks, magnetic or optical cards, other types of machine-readable mediums suitable for storing electronic instructions, or any suitable combination thereof.

In some of example embodiments, one or more memory 210 may store data used for the operations described herein. This includes memory 210 storing instructions (e.g., software, logic, code, etc.) in non-transitory media (e.g., random access memory (RAM), read only memory (ROM), FPGA, EPROM, etc.) such that the instructions are executed to carry out the activities described in this disclosure based on particular needs. In some embodiments, memory 210 may comprise non-transitory computer-readable media, including one or more memory devices such as volatile memory such as dynamic RAM (DRAM), nonvolatile memory (e.g., ROM), flash memory, solid-state memory, and/or a hard drive. In some embodiments, memory 210 may share a die with processing circuitry 208. Memory 210 may include algorithms, code, software modules, and applications, which may be executed by processing circuitry 208. The data being tracked, sent, received, or stored in tiered software framework 200 may be provided in any database, register, table, cache, queue, control list, or storage structure, based on particular needs and implementations, all of which could be referenced in any suitable timeframe.

Communication circuitry 212 may be configured for managing wired or wireless communications for the transfer of data in tiered software framework 200. The term “wireless” and its derivatives may be used to describe circuits, devices, systems, methods, techniques, communications channels, etc., that may communicate data through modulated electromagnetic radiation in a nonsolid medium. The term does not imply that the associated devices do not contain any wires, although in some embodiments they might not. Communication circuitry 212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long Term Evolution (LTE) project along with any amendments, updates, and/or revisions (e.g., advanced LTE project, ultramobile broadband (UMB) project (also referred to as “3GPP2”), etc.). Communication circuitry 212 may operate in accordance with a Global System for Mobile Communication (GSM), General Packet Radio Service (GPRS), Universal Mobile Telecommunications System (UMTS), High-Speed Packet Access (HSPA), Evolved HSPA (E-HSPA), or LTE network. Communication circuitry 212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication circuitry 212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication circuitry 212 may operate in accordance with other wireless protocols in other embodiments. Communication circuitry 212 may include antennas to facilitate wireless communications and/or to receive other wireless communications.

In some embodiments, communication circuitry 212 may manage wired communications, such as electrical, optical, or any other suitable communication protocols (e.g., the Ethernet, Internet). Communication circuitry 212 may include multiple communication chips. For instance, a first communication chip may be dedicated to shorter-range wireless communications such as Wi-Fi or Bluetooth, and a second communication chip may be dedicated to longer-range wireless communications such as global positioning system (GPS), EDGE, GPRS, CDMA, WiMAX, LTE, EV-DO, or others. In some embodiments, a first communication chip may be dedicated to wireless communications, and a second communication chip may be dedicated to wired communications.

The example network environment may be configured over a physical infrastructure that may include one or more networks and, further, may be configured in any form including, but not limited to, local area networks (LANs), wireless local area networks (WLANs), virtual local area networks (VLANs), metropolitan area networks (MANs), wide area networks (WANs), virtual private networks (VPNs), Intranet, Extranet, any other appropriate architecture or system, or any combination thereof that facilitates communications in a network. In some embodiments, a communication link may represent any electronic link supporting a LAN environment such as, for example, cable, Ethernet, wireless technologies (e.g., IEEE 802.11x), ATM, fiber optics, etc. or any suitable combination thereof. In other embodiments, communication links may represent a remote connection through any appropriate medium (e.g., digital subscriber lines (DSL), telephone lines, T1 lines, T3 lines, wireless, satellite, fiber optics, cable, Ethernet, etc. or any combination thereof) and/or through any additional networks such as a WANs (e.g., the Internet).

In various embodiments, tiers 102 may be partitioned into a backend 214 and a frontend 216. Backend 214 may comprise tier-1 backend 214-1, tier-2 backend 214-2, and tier-3 backend 214-3 provisioned in one or more servers 204. Likewise, frontend 216 may comprise tier-1 frontend 216-1, tier-2 frontend 216-2, and tier-3 frontend 216-3 provisioned in one or more computing devices 206. Backend 214 may comprise various modules, logic, software engines and other components that are distributed (and common) across all users of tiered software framework 200. Backend 214 may execute operations for managing and processing data, performing computations, and facilitating communication between different components, such as components of advertisement application 100. In particular embodiments, backend 214 may include operations such as data management, business logic (e.g., advertisement application 100), user authentication and authorization, security and validation, APIs with third-party components such as web crawlers, payment processors, etc.

In a general sense, frontend 216 comprises at least a user interface using which human users interact with tiered software framework 200. Frontend 216 may also include libraries, forms, device integrators and other components as desired and based on particular needs. Frontend 216 may be presented on a suitable display device coupled to computing device 206 and appropriate to show visual indicators, such as a heads-up display, a computer monitor, a projector, a touchscreen display, a liquid crystal display (LCD), a light-emitting diode display, and/or a flat panel display. In various embodiments, frontend 216 may be specific to the particular one of tier 102. For example, frontend 216-1 at tier-1 may comprise certain functionalities available (and visible) only to subscriber 104-1, e.g., SaaS provider, software developer. Frontend 216-2 at tier-2 may comprise certain functionalities available (and visible) only to tier-2 subscriber 104-2. Frontend 216-3 at tier-3 may comprise certain functionalities available (and visible) only to tier-3 subscriber 104-3.

Tiered software framework 200 described and shown herein (and/or its associated structures) may also include suitable interfaces for receiving, transmitting, and/or otherwise communicating data or information in a network environment. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

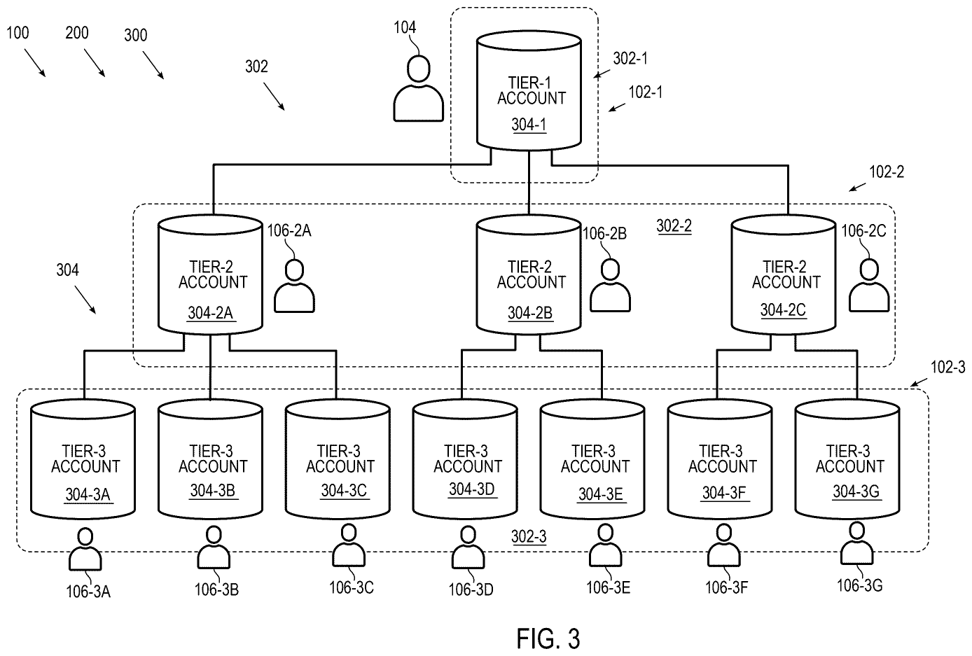

FIG. 3 is a simplified block diagram illustrating example details of data hierarchy 300 of tiered software framework 200 implementing advertisement application 100, according to some embodiments of the present disclosure. In various embodiments, data 302 communicated in tiered software framework 200 may be exclusively received from users such as subscriber 104-1 and subscribers 104-2, and 104-3; in some other embodiments, data 302 may also be received from other sources, such as third parties and/or from the Internet. Examples of data 302 include business niche targeted by subscribers 104, marketing activities such as on social media, target audience of subscribers 104, login credentials to access various marketing platforms, frequency of marketing activities, information to be included in the content of marketing posts, customer lists, business locations, marketing platform rules, and other such data relevant to the functionalities offered by tiered software framework 200. Data 302 may be stored in data lakes, databases, data warehouses, blockchains, file systems and other types of data storage facilities within the broad scope of the embodiments with corresponding accessing and viewing capabilities as described herein. In various embodiments, creative 110, copy 112, CTA 114 and brand kit 116 may be subsets of data 302.

Data 302 in each tier 102 may be contained within accounts 304 accessible and viewable with appropriate access credentials. For example, account 304-1 may be associated with subscriber 104-1. Account 304-1 may manage a plurality of accounts 304-2 at tier 102-2. Subscriber 104-2a may have a subscription to account 304-2a in plurality of accounts 304-2. Account 304-2a may manage a plurality of accounts 304-3 at tier 102-3. Subscriber 104-3a may have a subscription to account 304-3a in plurality of accounts 304-3; subscriber 104-3b may have a subscription to account 304-3b in plurality of accounts 304-3; and subscriber 104-3c may have a subscription to account 304-3c in plurality of accounts 304-3. In other words, subscriber 104-2a has three downstream subscribers at tier 102-3, namely subscribers 104-3 a, 104-3b, and 104-3c with their associated respective accounts 304-3a, 304-3b, and 304-3c. Likewise for other accounts shown in the figure. Note that such a framework is merely provided for illustrative purposes and should not be construed as a limitation. Any number of subscribers may be provided at tiers 102-2 and 102-3 in tiered software framework 200 within the broad scope of the embodiments.

In various embodiments, data 302 may be arranged in data hierarchy 300 for different accounts 304 such that certain users can view and access only a subset of data 302 according to their respective tier 102 and access credentials based on particular needs (e.g., user credentials may indicate which tier 102 and which corresponding accounts 304 are available for access and view). Such accounts 304 may be facilitated by a suitable user interface at frontend 216 for viewing the accessible data. Appropriate user authentication and authorization engines running in backend 214 may ensure that accounts 304 are maintained as desired and appropriate privacy blocks are applied at appropriate tiers 102.

In the example illustrated herein, tier-1 data 302-1 may be of account 304-1; tier-2 data 302-2 may be of accounts 304-2a, 304-2b and 304-2c corresponding to subscribers 104-2a, 104-2b and 104-2c, respectively; tier-3 data 302-3 may be of accounts 304-3a . . . 304-3g corresponding to subscribers 104-3a . . . 104-3g. Subscribers 104-3a . . . 104-3g may access and view their own respective accounts 304-3a . . . 304-3g; however, they cannot access or view other accounts 304 in the same tier 102-3 or in upstream tiers 102-2 or 102-1. Note that accessing and viewing an account refers to accessing and viewing the data of the account. Subscribers 104-2a . . . 104-2c at tier 102-3 may access and view their own respective accounts 304-2a . . . 304-2c as well as downstream accounts 304-3 of their respective subscribers 104-3; however, they cannot access or view other accounts 304-2 in the same tier 102-2, or in downstream tier 102-3 not associated with their downstream subscribers 104-3, or in upstream tier 102-1. For example, subscriber 104-2a may access and view accounts 304-2a, 304-3a, 304-3b, and 304-3c; subscriber 104-2b may access and view accounts 304-2b, 304-3d, and 304-3e; subscriber 104-2c may access and view accounts 304-2c, 304-3f, and 304-3g. Subscriber 104-1 at tier 102-1 may access and view accounts 304-1 at tier 102-1, 304-2a . . . 304-2c at tier 102-2, and 304-3a . . . 304-3g at tier 102-3.

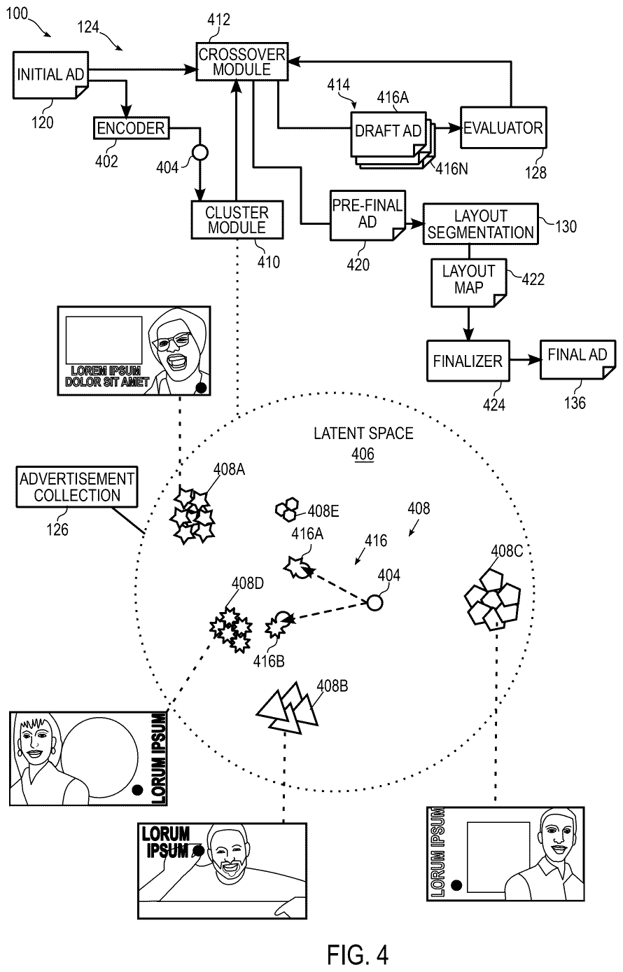

FIG. 4 is a simplified diagram illustrating example details of optimization engine 124 in advertisement application 100 according to some embodiments. Optimization engine 124 may comprise an encoder 402 that converts initial advertisement 120 into an embedding 404. Encoder 402 comprises a deep learning model trained to generate embeddings of advertisements. Any suitable deep learning model may be used in encoder 402. In some embodiments, encoder 402 may be provisioned in AI model 132 and access through API 134. In other embodiments, encoder 402 may be provisioned in optimization engine 124.

A plurality of previously generated advertisements in advertisement collection 126 may be encoded by encoder 402 in a multi-dimensional latent space 406. In various embodiments, latent space 406 comprises a plurality of embeddings. In some embodiments, latent space 406 may be generated along with embedding 404; in other embodiments, latent space 406 may be generated previously, and stored suitably in a memory storage. Such latent space 406 may be invoked by optimization engine 124 when initial advertisement 120 is received.

The embeddings in latent space 406 may be clustered into one or more clusters 408, which may be identified using a clustering algorithm of a cluster module 410. For example, k-means clustering partitions n observations into k clusters in which each observation belongs to the cluster with the nearest mean (e.g., cluster centers or cluster centroid), serving as a prototype of the cluster. Other examples of clustering algorithms include: hierarchical density-based spatial clustering of applications with noise (HDBSCAN), uniform manifold approximation and projection (UMAP), etc. Different clustering algorithms may find different clusters on the same set of embeddings. For example, some clustering algorithms may find two or more clusters where another clustering algorithm may find just one, depending on the resolution of the clustering. Any suitable clustering algorithm and corresponding resolution may be used in the embodiments disclosed herein to identify clusters 408.

Clusters 408 are observed organically and the clustering algorithm merely serves to identify them as such; in other words, clusters 408 are an artifact of the advertisements. Because the advertisements comprise discrete elements, such as creative 110, copy 112, CTA 114, and brand kit 116, their layouts tend to follow certain discontinuous patterns that may fall into clusters. Examples of the patterns are: creative 110 on the right, with copy 112 on the left, and CTA 114 on the bottom in one cluster; creative 110 in the background, copy 112 on the bottom, CTA 114 on the top right; and so on. Thus, embeddings of advertisements with creative 110 on the right may fall into one cluster, differentiated from another cluster in which creative 110 is on the left; and so on. On the other hand, within any one cluster 408, there may be a continuum of patterns, for example, text font ranging between 10 pt and 25 pt; or color ranging from light yellow to deep orange; and so on. Another clustering algorithm may identify clusters 408 in which the advertisements have a non-black background. Yet another clustering algorithm may identify clusters 408 that have different colored headlines in copy 112.

Different clustering algorithms may be tailored based on different criteria. In a general sense, the clustering algorithm may be selected based on previously identified criteria that are applicable for the business needs of the current advertisement being generated. For example, assume that subscriber 104-3a that has originated request 108 is a dentistry business. Based on previously published advertisements for the same or other dentistry businesses, the clustering criteria may comprise the type of foreground image. On the other hand, assume that subscriber 104-3a that has originated request 108 is a plumbing business. Based on previously published advertisements for the same or other plumbing businesses, the clustering criteria may comprise the colors in the product image and size of the text. Various other clustering criteria may be used within the broad scope of the embodiments. Note that although the clustering criteria are described in reference to the advertisements, the clustering algorithm and the actual clustering criteria are based on the embeddings; in other words, they are numerical criteria, not qualitative ones. The numerical clustering criteria may be translated from qualitative criteria previously and stored as appropriate settings in advertisement application 100.

In various embodiments, optimization engine 124 may be configured to use certain clustering algorithms based on specific business attributes of subscriber 104-3, such as types of businesses, markets, target customers, etc. In various other embodiments, optimization engine 124 may be configured to use specific clustering algorithms based on specific attributes of the publishing medium of the final advertisement, such as social media, website, email, etc. Various other attributes may be specified in preconfigured settings for choosing the clustering algorithm. In other embodiments, the same clustering algorithm may be used for all analysis, irrespective of the business, publishing medium, etc.

Each embedding may be associated with a separate actual engagement rate such as actual (i.e., observed, measured) CTR; each cluster 408 may therefore have a mean or average CTR. The term “actual” is used herein to distinguish from a “predicted” CTR. Predicted CTR may be computed from various machine learning models trained on actual data. The predicted CTR is used in various embodiments to test the viability of a potential advertisement layout as described further below. For example, assume that clusters 408a-408d are identified in latent space 406. Cluster 408a may comprise embeddings of advertisements in which creative 110 comprises a static foreground image and a multimedia background; copy 112 comprises text in bold under the multimedia background, to the left of the foreground image; and CTA 114 is at the bottom right-hand corner, overlaying the foreground image. Cluster 408b may comprise embeddings of advertisements in which creative 110 comprises a static background image; copy 112 comprises text overlaid on the image; and CTA 114 is superimposed on the product image.

Cluster 408c may comprise embeddings of advertisements in which creative 110 comprises a static foreground image rotated partially to the right in front of a background image; copy 112 comprises text rotated sideways and placed to the left; and CTA 114 is located on the left bottom corner of the background image. Cluster 408d may comprise embeddings of advertisements in which creative 110 comprises a static foreground image rotated partially to the left in front of a non-rectangular background product image against a contrasting background; copy 112 comprises text in bold turned sideways at the right-hand side; and CTA 114 is at the bottom right hand side, far from the foreground image. Various other clusters, such as cluster 408e, may also be identified, but are not particularly shown merely for succinctness and so as not to clutter the drawing. Note that these examples are listed here merely for illustrative purposes and are not meant to be limitations. Any layout and choice of creative 110, copy 112, CTA 114 and/or brand kit 116 may be provided in embeddings of clusters 408 within the broad scope of the embodiments.

A crossover module 412 executing in optimization engine 124 may execute a genetic algorithm to generate a population 414 comprising one or more draft advertisements 416a-416n from initial advertisement 120 as follows:
A predetermined number n of clusters 408 having high CTR may be identified in latent space 406 by cluster module 410 and provided to crossover module 412. Continuing the example above, assume that clusters 408a and 408d have the highest average CTR. Starting with initial advertisement 120, population 414 of n draft advertisements 416a-416n may be generated by adjusting positional offsets and scaling factors of identified clusters 408. Continuing the example above, draft advertisements 416a and 416b may be generated based on attributes of embeddings in clusters 408a and 408d, respectively. In one example, draft advertisement 416a may be generated by modifying initial advertisement 120 such that the image is focused on the person's face; copy 112 is similarly sized as advertisements associated with cluster 408a; etc. Likewise, draft advertisement 416b may be generated by modifying initial advertisement 120 such that the image is turned towards the left and brought to the foreground; copy 112 is similarly sized as advertisements associated with cluster 408d; etc.

Evaluator 128 may be used to predict the engagement rate, such as CTR, for each draft advertisement 416a-416n. Any suitable machine learning model may be used to predict the CTR. In some embodiments, evaluator 128 may access AI models 132 through API 134 to perform the computations. The predicted CTRs may be fed to crossover module 412, which may choose the top k candidates as the seed population in the next iteration. Thereafter population 414 comprising draft advertisements 416a-416n may be generated combining positional offsets and scaling factors for individual design elements across pairs of designs from the variants having the highest CTR in the parent population using a crossover algorithm. This process is repeated for a predetermined number of iterations, for example, 20 iterations. The candidate embedding with the highest engagement rate, such as CTR, is selected as a pre-final advertisement 420.

In some embodiments, evaluator 128 may be configured with a similarity metric. In such embodiments, images and text in draft advertisements 416a-416n may be compared against the original creative 110, copy 112, CTA 114, and brand kit 116 provided in request 108. The combination of CTR and similarity metric may be used to evaluate candidates in subsequent iterations.

Layout segmentation module 130 may receive the pre-final advertisement 420, and identify the various components therein, namely, creative 110, copy 112, CTA 114 and brand kit 116. At this point, after several iterations through crossover module 412, these components may not correspond exactly to the input components provided in request 108. For example, the product image in pre-final advertisement 420 may not correspond exactly to the product image in creative 110 because the crossover variants have modified the image in some ways. Even though the similarity metric may be used for evaluating candidates, the resultant images and text need not be identical to the original images and text because of the crossover algorithm. Layout segmentation module 130 may generate a layout map 422 from the identified components in pre-final advertisement 420. Layout map 422 may be akin to a template in some embodiments. A finalizer 424 may insert original images and text from request 108 into layout map 422 to generate final advertisement 136.

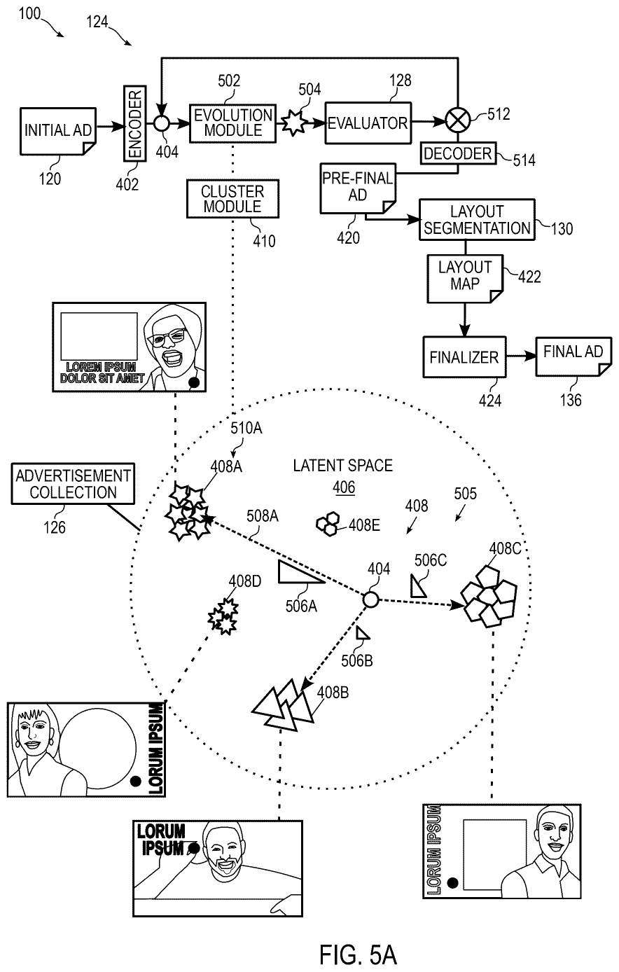

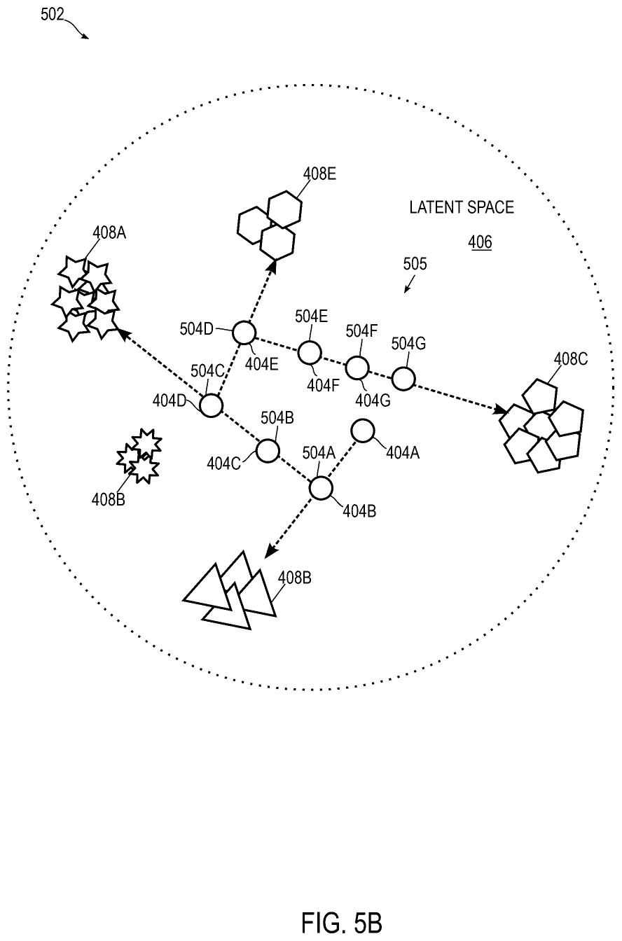

FIGS. 5A-5B are simplified diagrams illustrating example details of optimization engine 124 in advertisement application 100 according to some embodiments. Initial advertisement 120 may be encoded into embedding 404 by encoder 402. Embedding 404 may be in latent space 406, comprising clusters 408 identified by cluster module 410. An evolution module 502 executing in optimization engine 124 may generate a candidate embedding 504 from embedding 404 based at least on: (i) purposeful movements 505 in latent space 406 towards selected clusters 408, and (ii) predicted engagement rates, such as CTR, of candidate embedding 504 derived from purposeful movements 505. Purposeful movements 505 are derived based on gradients 506 between embedding 404 and clusters 408. For example, gradient 506a between embedding 404 and cluster 408a is the ratio of the difference 510a between the average engagement rate associated with cluster 408a and embedding 404 and distance 508a between the centroid of cluster 408a and embedding 404 in latent space 406.

In various embodiments, evolution module 502 may execute a sequence of steps, each purposeful movement 505 comprising one sequence. The sequence comprises: (i) calculating, for each cluster 408: (i) distance 508 between embedding 404 and the centroid of cluster 408, (ii) difference 510 in the engagement rate of embedding 404 and an average engagement rate of cluster 408, and (iii) gradient 506 as a ratio of difference 510 to distance 508. After all identified clusters 408 in latent space 406 have been evaluated, one of clusters 408, e.g., 408a, having a larger gradient 506 than other clusters may be selected. Embedding 404 may be modified into candidate embedding 504 according to attributes of selected cluster 408a.

Evaluator 128 may be used to predict the engagement rate, such as CTR, for candidate embedding 504. In some such embodiments, there may be one-to-one association between embeddings and CTR based on the advertisements associated with the respective embeddings and the CTR of such advertisements. A decision module 512 may compare the engagement rate of candidate embedding 504 to the engagement rate of initial advertisement 120, or a predetermined engagement rate threshold. Responsive to determining that the engagement rate of candidate embedding 504 is less than the engagement rate of initial advertisement 120, or a predetermined engagement rate threshold, evaluator may reset the initializations of the algorithm such that candidate embedding 504 is reset to initial embedding 404. The operations may continue until the predicted engagement rate of candidate embedding 504 is greater than the predicted engagement rate in the previous iteration or more than the predetermined engagement rate threshold.

FIG. 5B explains the operations in further detail. Initial advertisement 120 generated by forwarder 118 and sent to advertisement generator 122 may be encoded as initial embedding 404a in latent space 406. In the first iteration A, evolution module 502 may evaluate gradients 506a-506e between embedding 404a and clusters 408a-408e. A determination may be made that gradient 506b with cluster 408b is higher than other gradients.

Note the difference in this method from the previously described method in reference to FIG. 4. Here, even though cluster 408b has a lower engagement rate than cluster 408a, it is closer to embedding 404, leading to higher gradient 506b. Thus, cluster 408b may not be selected to modify embedding 404 in the previously described method because of its lower average engagement rate, whereas it is selected in this method described in reference to FIGS. 5A-5B. Selecting cluster 408b may allow for more efficient computations by balancing exploration with exploitation.

Candidate embedding 504a may be generated by modifying parameters in embedding 404a according to aspects of cluster 408b. Purposeful movement 505a (not shown to prevent clutter, but direction indicated by dotted-line arrows) may comprise such modification in the direction of cluster 408b. Engagement rate may be predicted for candidate embedding 504a. A determination may be made by decision module 512 that the predicted engagement rate is more than the engagement rate of initial advertisement 120, but less than the predetermined threshold. Embedding 504a may be reset as initial embedding 404b.

In the second iteration B, evolution module 502 may evaluate gradients 506a-506e between embedding 404b and clusters 408a-408e. A determination may be made that gradient 506a with cluster 408a is higher than other gradients. Candidate embedding 504b may be generated by modifying parameters in embedding 404b according to aspects of cluster 408a. Purposeful movement 505b (not shown to prevent clutter, but direction indicated by dotted-line arrows) may comprise such modification in the direction of cluster 408a. Engagement rate may be predicted for candidate embedding 504b. A determination may be made by decision module 512 that the predicted engagement rate is more than the engagement rate in the previous iteration, but less than the predetermined threshold. Embedding 504b may be reset as initial embedding 404c.

In the third iteration C, evolution module 502 may evaluate gradients 506a-506e between embedding 404c and clusters 408a-408e. A determination may be made that gradient 506a with cluster 408a is higher than other gradients. Candidate embedding 504c may be generated by modifying parameters in embedding 404c according to aspects of cluster 408a. Purposeful movement 505c (not shown to prevent clutter, but direction indicated by dotted-line arrows) may comprise such modification in the direction of cluster 408a. Engagement rate may be predicted for candidate embedding 504c. A determination may be made by decision module 512 that the predicted engagement rate is less than the engagement rate in the previous iteration. Embedding 504c may be reset as initial embedding 404d.

In the fourth iteration D, evolution module 502 may evaluate gradients 506a-506e between embedding 404d and clusters 408a-408e. A determination may be made that gradient 506e with cluster 408e is higher than other gradients. Candidate embedding 504d may be generated by modifying parameters in embedding 404d according to aspects of cluster 408e. Purposeful movement 505d (not shown to prevent clutter, but direction indicated by dotted-line arrows) may comprise such modification in the direction of cluster 408e. Engagement rate may be predicted for candidate embedding 504d. A determination may be made by decision module 512 that the predicted engagement rate is less than the engagement rate in the previous iteration. Embedding 504d may be reset as initial embedding 404e.

The iterations may continue until it is determined that engagement rate of candidate embedding 504g is higher than the engagement rate of the previous iteration and the predetermined threshold. Thereafter, candidate embedding 504 may be decoded by a decoder 514 as pre-final advertisement 420 and the operations may continue as explained further below. Note that the example provided here explaining iterations a-g is simply for explanation and is not meant as a limitation. Any number of iterations may be executed in advertisement application 100 without departing from the scope of the embodiments.

Comparing this method to the method described in reference to FIG. 4, two differences may be noted: (1) instead of a population of candidate embeddings as in the previously described method, here, only one candidate is selected per iteration, making the calculation faster; and (2) in this method, the selection of a candidate embedding is based on purposeful movements towards clusters that have a high engagement rate gradient 506 rather than random movements towards high-engagement rate clusters as in the previously described method. The second difference, namely, the purposeful movement, results in cluster 408 b being ignored and the final candidate embedding 504g being closer to cluster 408c in the example described. On the other hand, in the previously described method, because cluster 408b had a high engagement rate, it was chosen to generate a candidate embedding irrespective of its distance 508b from embedding 404. Because distance 508 in latent space 406 can be a measure of relevance, ignoring it can make the resulting candidate embedding less effective than desired. The method described in FIGS. 5A-5B uses purposeful movements that consider not only the difference 510 in engagement rates, but also the distance 508 from the embedding under review, achieving a balance between exploration and exploitation because the iterations tend to converge faster.

In some embodiments, evaluator 128 may be configured with a similarity metric. In such embodiments, draft advertisements may be decoded from candidate embeddings 504; the images and text in such draft advertisements may be compared against the original creative 110, copy 112, CTA 114, and brand kit 116 provided in request 108. The combination of CTR and similarity metric may be used to evaluate candidates in subsequent iterations.

Layout segmentation module 130 may receive the pre-final advertisement 420, and identify the various components therein, namely, creative 110, copy 112, CTA 114 and brand kit 116. Layout segmentation module 130 may generate a layout map 422 from the identified components in pre-final advertisement 420. A finalizer 424 may replace the identified components with the original images and text from request 108 into layout map 422 to generate final advertisement 136.

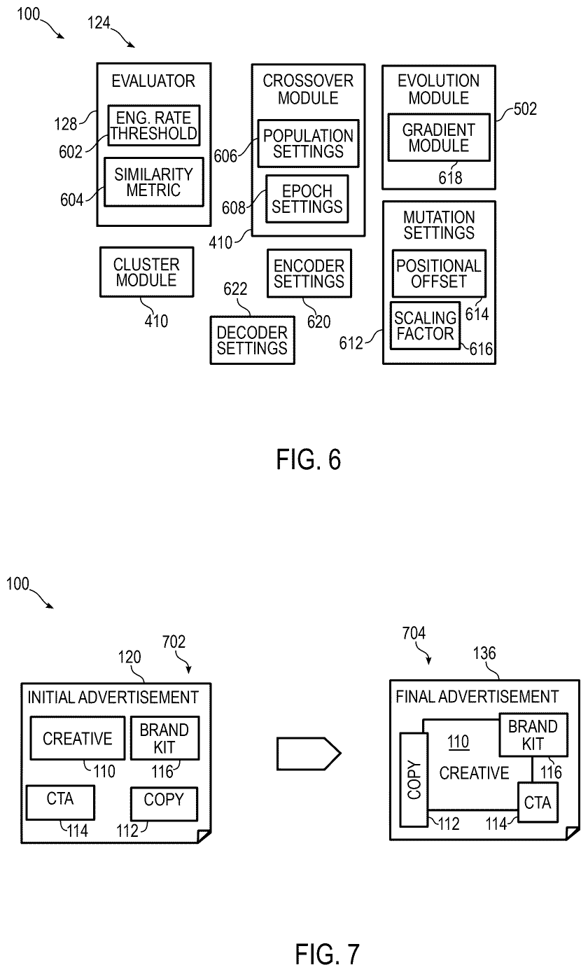

FIG. 6 is a simplified block diagram illustrating example details of optimization engine 124 in advertisement application 100 according to some embodiments. Evaluator 128 may be configured with an engagement rate threshold 602. In some embodiments, engagement rate threshold 602 may be the CTR. In some other embodiments, engagement rate threshold 602 may be impression count. In yet other embodiments, engagement rate threshold 602 may be the number of visits. Various types of customer engagement may be captured as a metric in engagement rate threshold 602. In some embodiments, evaluator 128 may be configured with a similarity metric 604. Engagement rate threshold 602 may be used in various operations to evaluate initial advertisement 120, draft advertisements 416a-416n; and draft advertisements created from candidate embedding 504 as desired and based on particular needs. In some embodiments, similarity metric 604 may also be used in the evaluations.

Crossover module 412 may be configured with population settings 606 and epoch settings 608. Population settings 606 may comprise information on the number of draft advertisements 416 to be included in any population 414. For example, population settings 606 may specify that the number of draft advertisements 416 in population 414 is 50. In such embodiments, 50 clusters 408 with high engagement rates may be selected and population 414 generated therefrom with number of draft advertisements 416 comprising initial advertisement 120 modified into 50 variants according to attributes of embeddings in respective 50 clusters 408. Epoch settings 608 may comprise the number of iterations to be performed by crossover module 412. In some embodiments, the genetic algorithm may be executed for 20 iterations based on epoch settings 608.

Cluster module 410 may enable identification of clusters 408. Cluster module 410 may comprise any suitable cluster identifying algorithm, such as k-means clustering algorithm, HDBSCAN, UMAP, etc. In some embodiments, cluster module 410 may also compute an average engagement rate of identified clusters 408 as also a centroid of clusters 408 in latent space 406. Optimization engine 124 may be configured with mutation settings 612, comprising positional offset 614 and scaling factor 616. Positional offset 614 may include settings for the range or extreme values of positional offsets that are permissible to modify initial advertisement 120 into draft advertisements 416 or initial embedding 404 into candidate embedding 504. For example, the positional offset 614 may specify that creative 110 may be moved by 40% of the banner size along any direction. Likewise, scaling factor 616 may include settings for the range or extreme values of scaling factors that are permissible to modify initial advertisement 120 into draft advertisements 416 or initial embedding 404 into candidate embedding 504. For example, the scaling factor 616 may specify that the text size of copy 112 may not be increased more than 80% in any direction. In some embodiments, mutation settings 612 may be optional. In other embodiments, mutation settings 612 may be preconfigured with default values that can be changed by the user and provided in request 108. In yet other embodiments, mutation settings 612 may not be changed from factory settings.

Evolution module 502 may be configured with gradient module 618 that computes distance 508, difference 510 and gradient 506 as the ratio of difference 510 to distance 508. In some embodiments, gradient module 618 may also be configured to sort the calculated gradients 506 and determine the highest gradient 506 for further calculations. In some embodiments, optimization engine 124 may be configured with encoder settings 620 for encoder 402 and decoder settings 622 for decoder 514. Encoder settings 620 comprise settings for the embedding algorithm that translates initial advertisement 120 to embedding 404. In some embodiments, the settings can include selection of a suitable algorithm or machine model; in other embodiments, the settings can include values of parameters of a particular algorithm or machine model or number of algorithms or machine models. Likewise, decoder settings 622 comprise settings for the algorithm used to decode embedding 504 into a draft advertisement. In some embodiments, the settings can include selection of a suitable algorithm or machine model; in other embodiments, the settings can include values of parameters of a particular algorithm or machine model or number of algorithms or machine models.

FIG. 7 is a simplified diagram illustrating example details of advertisement application 100 according to some embodiments. Initial advertisement 120 generated by forwarder 118 may have a tentative layout 702 in which creative 110, copy 112, CTA 114 and brand kit 116 are arranged in a preconfigured way. Final advertisement 136 generated by advertisement generator 122 may have a different layout 704. In the example shown, creative 110 has been moved to the background and enlarged; copy 112 has been turned sideways and moved to the left; CTA 114 has been moved from left to right and reduced in size; and brand kit 116 remains unchanged. Colors may also be modified suitably in some embodiments. Final advertisement 136 is configured to perform better in terms of engagement rate (e.g., CTA) than initial advertisement 120 according to various embodiments.

Although the present disclosure has been described in detail with reference to particular arrangements and configurations, these example configurations and arrangements may be changed significantly without departing from the scope of the present disclosure. For example, although the present disclosure has been described with reference to particular network systems such as cloud networks, advertisement application 100 may be applicable to other networks such as LANs. Moreover, although tiered software framework 200 has been illustrated with reference to particular elements and operations that facilitate the software process, these elements, and operations may be replaced by any suitable architecture or process that achieves the intended functionality of advertisement application 100.

### Example Methods

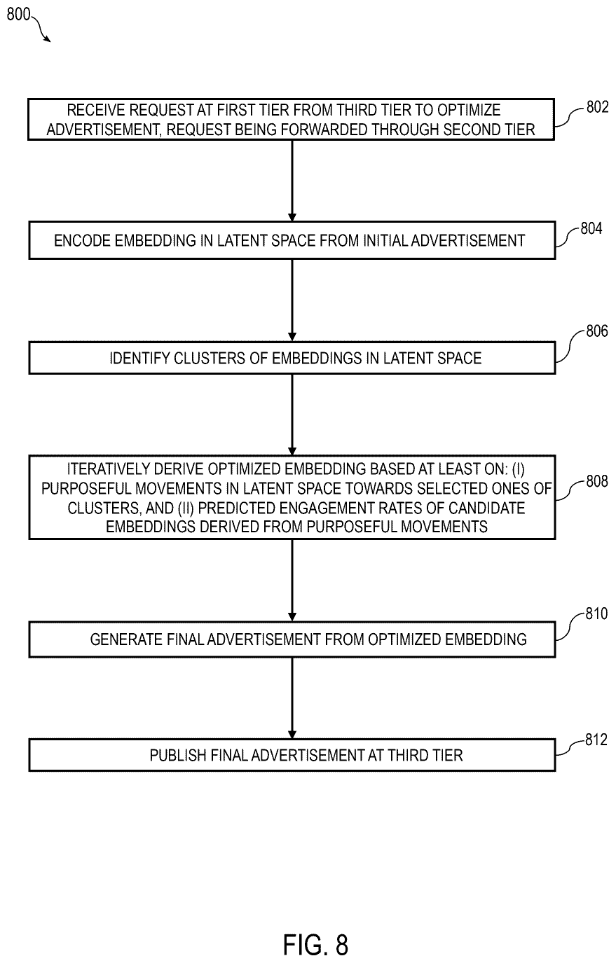

FIG. 8 is a simplified flow diagram illustrating example operations 800 associated with advertisement application 100, according to some embodiments. At 802, advertisement generator 122 at tier 102-1 may receive request 108 originating at tier 102-3 to optimize initial advertisement 120, request 108 being forwarded, after processing, through forwarder 118 in tier 102-2. At 804, encoder 402 may encode embedding 404 in latent space 406 from initial advertisement 120. At 806, cluster module 410 may identify clusters 408 in latent space 406. At 808, optimization engine 124 may iteratively derive optimized embedding 504 (e.g., 504g) based at least on: (i) purposeful movements 505 in latent space 406 towards selected ones of clusters 408; and (ii) predicted engagement rates, such as CTR, of candidate embeddings 504 derived from purposeful movements 505. At 810, final advertisement 136 may be derived from optimized embedding 504, for example, by decoding into pre-final advertisement 420, and finalizing layout 704 based on layout map 422. At 812, final advertisement 136 may be published at tier 102-3.

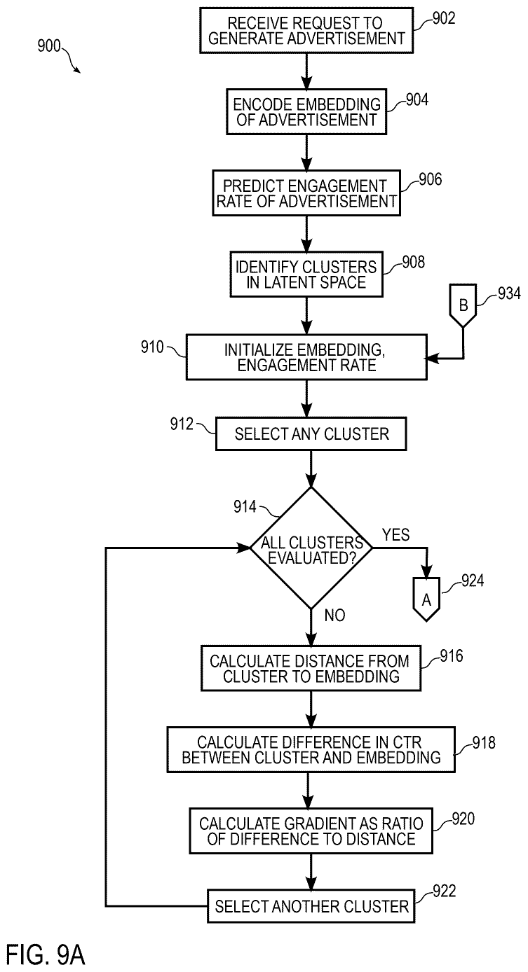

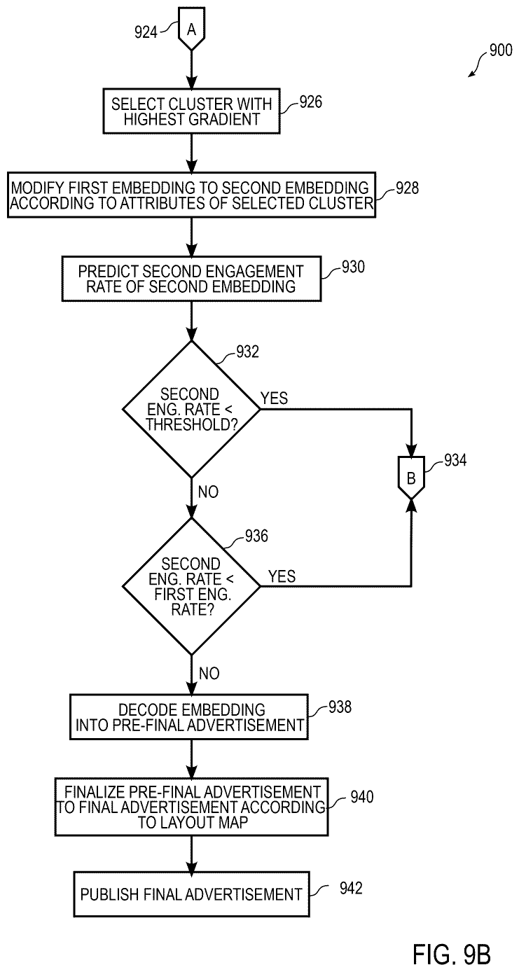

FIGS. 9A-9B are simplified flow diagrams illustrating example operations 900 associated with advertisement application 100 according to some embodiments. At 902, advertisement generator 122 may receive request 108 to generate an advertisement. In various embodiments, request 108 may be forwarded to advertisement generator 122 by forwarder 118. At 904, encoder 402 may generate embedding 404 from initial advertisement 120. At 906, evaluator 128 may predict the engagement rate (e.g., CTR) of initial advertisement 120. At 908, cluster module 410 may identify clusters 408 in latent space 406. At 910, optimization engine 124 may initialize embedding 404 and associated engagement rate as a first embedding and a first engagement rate, respectively. Note that this initialization step is for computational purposes only; it merely sets a counter to 1, denoting these components, namely embedding 404 and the predicted CTR as initial values in the iterations. At 912, any cluster 408 may be selected. Assume, merely for example purposes, that cluster 408 a is selected. At 914, a determination may be made if all clusters 408 have been evaluated. If not, as would be the case with the first iteration, at 916, distance 508a from the selected cluster 408a to embedding 404 may be calculated. At 918, difference 510 a in CTR between selected cluster 408 a and embedding 404 may be calculated. At 920, gradient 506 a may be calculated as the ratio of difference 510 a to distance 508a. At 922, another cluster, say 408b, may be selected and the operations may revert to 914 and continue until all gradients 506 have been calculated. The operations may then step to 924.

Turning to FIG. 9B, continuing from step 924, at 926, the cluster, say 408b, with highest gradient 506b may be selected. At 928, first embedding 404 a may be modified to candidate embedding 504a (which may be considered as a second embedding relative to embedding 404a initialized as the first embedding at 910) according to attributes of selected cluster 408b. At 930, evaluator 128 may predict the second engagement rate of candidate embedding 504a. At 932, a determination may be made whether the second engagement rate is less than engagement rate threshold 602. If yes, the operations step to 934 and turning back to FIG. 9A, to 910, at which candidate embedding 504a may be reset as first embedding 404b, and the second engagement rate may be reset as the first engagement rate for the next iteration. The operations may continue thereafter to 912 and so on.

Turning back to FIG. 9B, if it is determined at 932 that the second engagement rate is not less than engagement rate threshold 602, a determination may be made at 936 whether the second engagement rate is less than the first engagement rate. In relation to the iteration, the first engagement rate of the first iteration is the predicted engagement rate of initial advertisement 120 or corresponding embedding 404a. In subsequent iterations, the first engagement rate is the predicted engagement rate of candidate embeddings 504 of the previous iteration. If the determination at 936 is that the second engagement rate is less than the first engagement rate, the operations step to 934, and continue onto to the next iteration from 910. On the other hand, if the second engagement rate is not less than the first engagement rate, at 938, candidate embedding 504 may be decoded into pre-final advertisement 420. At 940, pre-final advertisement 420 may be finalized to final advertisement 136 according to layout map 422. For example, creative 110, copy 112, CTA 114 and brand kit 116 in request 108 may be inserted into layout map 422 generated based on pre-final advertisement 420. At 942, final advertisement 136 may be published at tier 102-3.

FIG. 10 is a simplified flow diagram illustrating example operations 1000 that may be associated with advertisement application 100. At 1002, candidate embedding 504 may be generated by evolution module 502 according to the methods described in reference to FIGS. 5A-5B. At 1004, candidate embedding 504 may be decoded into a draft advertisement by decoder 514. At 1006, evaluator 128 may compute similarity metric 604 of images in the draft advertisement with original images in initial advertisement 120. The computation may comprise identifying the images, and comparing the images in the draft advertisement with the corresponding images in initial advertisement 120, and assigning a similarity metric based on extent of similarity. In some embodiments, the stronger the overall similarity, the greater is the similarity metric assigned. In other embodiments, the similarity metric may be assigned based on similarity of colors, similarity of edges, similarity of contours, similarity of image values, etc. In some embodiments, similarity of different images may be computed separately and aggregated suitably. In other embodiments, the overall similarity of the entire advertisement may be evaluated. Various different metrics may be used to evaluate the similarity metric 604. At 1008, a determination may be made whether similarity metric 604 is less than a predetermined similarity threshold. If so, the operations may continue the iterations at 1010, by resetting the candidate embedding as the first embedding in the next iteration and continuing thereafter. On the other hand, if similarity metric 604 is not less than the predetermined similarity threshold, at 1012, the iterations may be terminated.

In some embodiments, the use of similarity metric 604 may be in addition to use of engagement rate, so that operations 1000 may be included in operations 900 suitably. For example, turning back to FIG. 9B, after a determination that the second engagement rate is not less than the first engagement rate at 936, the operations may step to 1002 in FIG. 10. Thereafter, at 1012, instead of terminating the iterations, the operations may step to 938 in FIG. 9B and continue thereafter.

In various embodiments, substantially most operations described in FIGS. 8-10 are performed automatically without human intervention. Although FIGS. 8-10 illustrate various operations performed in a particular order, this is simply illustrative, and the operations discussed herein may be reordered and/or repeated as suitable. Further, additional operations which are not illustrated may also be performed without departing from the scope of the present disclosure. Also, various ones of the operations discussed herein with respect to FIGS. 8-10 may be modified in accordance with the present disclosure to automatically generate final advertisement 136 from initial advertisement 120 as disclosed herein. Although various operations are illustrated in FIGS. 8-10 once each, the operations may be repeated as often as desired.

It is important to note that the operations described with reference to the preceding figures illustrate only some of the possible scenarios that may be executed by, or within, advertisement application 100. Some of these operations may be deleted or removed where appropriate, or these steps may be modified or changed considerably without departing from the scope of the discussed concepts. In addition, the timing of these operations may be altered considerably and still achieve the results taught in this disclosure. The preceding operational flows have been offered for purposes of example and discussion.

### SELECT EXAMPLES

Example 1 provides a method for optimizing advertisements in a tiered software framework, the method including: receiving a request to optimize an advertisement, in which: the request is received at one tier from another tier of a tiered software framework, and the tiered software framework comprises a plurality of tiers differentiated by access management policies; encoding in a latent space using a machine model, an embedding of the advertisement, the latent space comprising other embeddings of previously published advertisements having corresponding actual engagement rates; identifying clusters in the latent space; starting with the embedding of the advertisement, iteratively deriving an optimized embedding based at least on: (i) purposeful movements in the latent space towards selected ones of the clusters, and (ii) predicted engagement rates of candidate embeddings derived from the purposeful movements, in which the purposeful movements are based at least on relative differences in engagement rates and respective distances of the selected clusters from candidate embeddings derived in preceding iterations; generating a final advertisement from the optimized embedding, the final advertisement generated at the one tier; and publishing the final advertisement at the another tier.

Example 2 provides the method of example 1, in which iteratively deriving the optimized embedding comprises: setting the embedding as a first embedding; predicting a first engagement rate of the first advertisement; executing a sequence of steps, each purposeful movement being one sequence, the sequence including: calculating, for each cluster: (i) a distance between the first embedding and a centroid of the cluster, (ii) a difference in the first engagement rate and an average engagement rate of the cluster, and (iii) a gradient as a ratio of the difference to the distance; selecting one of the clusters having a larger gradient than other clusters; modifying the first embedding into a second embedding according to attributes of the selected cluster; predicting a second engagement rate of the second embedding; and responsive to determining that the second engagement rate is less than at least one of: (i) the first engagement rate or (ii) a predetermined engagement rate threshold: resetting the second embedding as the first embedding, and resetting the second engagement rate as the first engagement rate; and repeatedly executing the sequence of steps until the second engagement rate is not less than at least one of: (i) the first engagement rate or (ii) the predetermined engagement rate threshold.

Example 3 provides the method of example 2, in which modifying the first embedding comprises altering parameter values in the first embedding by a scale factor proportional to the gradient calculated for the selected cluster.

Example 4 provides the method of example 2, in which: the first advertisement in the request comprises an original image, the method further includes, in each sequence of steps: decoding the second embedding into a second advertisement, and calculating a similarity metric between a generated image in the second advertisement and the original advertisement, and resetting the second advertisement, the second embedding, and the second engagement rate is responsive further to determining that the similarity metric is below a predetermined similarity threshold.

Example 5 provides the method of example 1, in which the request originates from an account at the another tier of the tiered software framework, the another tier comprises multiple accounts, and the access management policies specify that data from the one tier is not accessible at the another tier, data from the another tier is accessible at the one tier, and data in one account is not accessible by another account.

Example 6 provides the method of example 5, in which the previously published advertisements are associated with different accounts at the another tier.
Example 7 provides the method of example 1, in which the engagement rate comprises CTR.
Example 8 provides non-transitory computer-readable tangible media that includes instructions for execution, which when executed by a processor of a computing device, is operable to perform operations including: receiving a request to optimize an advertisement, in which: the request is received at one tier from another tier of a tiered software framework, and the tiered software framework comprises a plurality of tiers differentiated by access management policies; encoding in a latent space using a machine model, an embedding of the advertisement, the latent space comprising other embeddings of previously published advertisements having corresponding actual engagement rates; identifying clusters in the latent space; starting with the embedding of the advertisement, iteratively deriving an optimized embedding based at least on: (i) purposeful movements in the latent space towards selected ones of the clusters, and (ii) predicted engagement rates of candidate embeddings derived from the purposeful movements, in which the purposeful movements are based at least on relative differences in engagement rates and respective distances of the selected clusters from candidate embeddings derived in preceding iterations; generating a final advertisement from the optimized embedding, the final advertisement generated at the one tier; and publishing the final advertisement at the another tier.

Example 9 provides the non-transitory computer-readable tangible media of example 8, in which iteratively deriving the optimized embedding includes: setting the embedding as a first embedding; predicting a first engagement rate of the first advertisement; executing a sequence of steps, each purposeful movement being one sequence, the sequence including: calculating, for each cluster: (i) a distance between the first embedding and a centroid of the cluster, (ii) a difference in the first engagement rate and an average engagement rate of the cluster, and (iii) a gradient as a ratio of the difference to the distance; selecting one of the clusters having a larger gradient than other clusters; modifying the first embedding into a second embedding according to attributes of the selected cluster; predicting a second engagement rate of the second embedding; and responsive to determining that the second engagement rate is less than at least one of: (i) the first engagement rate or (ii) a predetermined engagement rate threshold: resetting the second embedding as the first embedding, and resetting the second engagement rate as the first engagement rate; and repeatedly executing the sequence of steps until the second engagement rate is not less than at least one of: (i) the first engagement rate or (ii) the predetermined engagement rate threshold.

Example 10 provides the non-transitory computer-readable tangible media of example 9, in which modifying the first embedding into a second embedding comprises a scale factor proportional to the gradient calculated for the selected cluster.

Example 11 provides the non-transitory computer-readable tangible media of example 9, in which: the first advertisement in the request comprises an original image, the operations further include, in each sequence of steps: decoding the second embedding into a second advertisement, and calculating a similarity metric between a generated image in the second advertisement and the original image, and resetting the second advertisement, the second embedding, and the second engagement rate is responsive further to determining that the similarity metric is below a predetermined similarity threshold.

Example 12 provides the non-transitory computer-readable tangible media of example 8, in which the request originates from an account at the another tier of the tiered software framework, the another tier comprises multiple accounts, and the access management policies specify that data from the one tier is not accessible at the another tier, data from the another tier is accessible at the one tier, and data in one account is not accessible by another account.

Example 13 provides the non-transitory computer-readable tangible media of example 12, in which the previously published advertisements are associated with different accounts at the another tier.

Example 14 provides the non-transitory computer-readable tangible media of example 8, in which the engagement rate comprises CTR.

Example 15 provides an apparatus including: a processing circuitry; a memory storing data; and a communication circuitry, in which the processing circuitry executes instructions associated with the data, the processing circuitry is coupled to the communication circuitry and the memory, and the processing circuitry and the memory cooperate, such that the apparatus is configured for: receiving a request to optimize an advertisement, in which: the request is received at one tier from another tier of a tiered software framework, and the tiered software framework comprises a plurality of tiers differentiated by access management policies; encoding in a latent space using a machine model, an embedding of the advertisement, the latent space comprising other embeddings of previously published advertisements having corresponding actual engagement rates; identifying clusters in the latent space; starting with the embedding of the advertisement, iteratively deriving an optimized embedding based at least on: (i) purposeful movements in the latent space towards selected ones of the clusters, and (ii) predicted engagement rates of candidate embeddings derived from the purposeful movements, in which the purposeful movements are based at least on relative differences in engagement rates and respective distances of the selected clusters from candidate embeddings derived in preceding iterations; generating a final advertisement from the optimized embedding, the final advertisement generated at the one tier; and publishing the final advertisement at the another tier.

Example 16 provides the apparatus of example 15, in which iteratively deriving the optimized embedding includes: setting the embedding as a first embedding; predicting a first engagement rate of the first advertisement; executing a sequence of steps, each purposeful movement being one sequence, the sequence including: calculating, for each cluster: (i) a distance between the first embedding and a centroid of the cluster, (ii) a difference in the first engagement rate and an average engagement rate of the cluster, and (iii) a gradient as a ratio of the difference to the distance; selecting one of the clusters having a larger gradient than other clusters; modifying the first embedding into a second embedding according to attributes of the selected cluster; predicting a second engagement rate of the second embedding; and responsive to determining that the second engagement rate is less than at least one of: (i) the first engagement rate or (ii) a predetermined engagement rate threshold: resetting the second embedding as the first embedding, and resetting the second engagement rate as the first engagement rate; and repeatedly executing the sequence of steps until the second engagement rate is not less than at least one of: (i) the first engagement rate or (ii) the predetermined engagement rate threshold.

Example 17 provides the apparatus of example 16, in which modifying the first embedding comprises altering parameter values in the first embedding by a scale factor proportional to the gradient calculated for the selected cluster.

Example 18 provides the apparatus of example 16, in which: the first advertisement in the request comprises an original image, the apparatus is further configured for: in each sequence of steps, calculating a similarity metric between a generated image in the second advertisement and the original image, and resetting the second advertisement, the second embedding, and the second engagement rate is responsive further to determining that the similarity metric is below a predetermined similarity threshold.

Example 19 provides the apparatus of example 15, in which the request originates from an account at the another tier of the tiered software framework, the another tier comprises multiple accounts, and the access management policies specify that data from the one tier is not accessible at the another tier, data from the another tier is accessible at the one tier, and data in one account is not accessible by another account.

Example 20 provides the apparatus of example 19, in which the previously published advertisements are associated with different accounts at the another tier.

The above description of illustrated implementations of the disclosure, including what is described in the abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize.

1. A method for optimizing advertisements in a tiered software framework, the method comprising:
receiving a request to optimize an advertisement, wherein:
the request is received at one tier from another tier of a tiered software framework, and
the tiered software framework comprises a plurality of tiers differentiated by access management policies;
encoding in a latent space using a machine model, an embedding of the advertisement, the latent space comprising other embeddings of previously published advertisements having corresponding actual engagement rates;
identifying clusters in the latent space;
starting with the embedding of the advertisement, iteratively deriving an optimized embedding based at least on: (i) purposeful movements in the latent space towards selected ones of the clusters, and (ii) predicted engagement rates of candidate embeddings derived from the purposeful movements, wherein the purposeful movements are based at least on relative differences in engagement rates and respective distances of the selected clusters from candidate embeddings derived in preceding iterations;
generating a final advertisement from the optimized embedding, the final advertisement generated at the one tier; and
publishing the final advertisement at the another tier.

2. The method of claim 1, wherein iteratively deriving the optimized embedding comprises:
setting the embedding as a first embedding;
predicting a first engagement rate of the first advertisement;
executing a sequence of steps, each purposeful movement comprising one sequence, the sequence comprising:
calculating, for each cluster: (i) a distance between the first embedding and a centroid of the cluster, (ii) a difference in the first engagement rate and an average engagement rate of the cluster, and (iii) a gradient as a ratio of the difference to the distance;
selecting one of the clusters having a larger gradient than other clusters;
modifying the first embedding into a second embedding according to attributes of the selected cluster;
predicting a second engagement rate of the second embedding; and
responsive to determining that the second engagement rate is less than at least one of: (i) the first engagement rate or (ii) a predetermined engagement rate threshold: resetting the second embedding as the first embedding, and resetting the second engagement rate as the first engagement rate; and
repeatedly executing the sequence of steps until the second engagement rate is not less than at least one of: (i) the first engagement rate or (ii) the predetermined engagement rate threshold.

3. The method of claim 2, wherein modifying the first embedding comprises altering parameter values in the first embedding by a scale factor proportional to the gradient calculated for the selected cluster.

4. The method of claim 2, wherein:
the first advertisement in the request comprises an original image, the method further comprises, in each sequence of steps:
decoding the second embedding into a second advertisement; and
calculating a similarity metric between a generated image in the second advertisement and the original image, and
resetting the second embedding and the second engagement rate is responsive further to determining that the similarity metric is below a predetermined similarity threshold.

5. The method of claim 1, wherein:
the request originates from an account at the another tier of the tiered software framework,
the another tier comprises multiple accounts, and
the access management policies specify that data from the one tier is not accessible at the another tier, data from the another tier is accessible at the one tier, and data in one account is not accessible by another account.

6. The method of claim 5, wherein the previously published advertisements are associated with different accounts at the another tier.

7. The method of claim 1, wherein the engagement rate comprises click-through-rate (CTR).

8. Non-transitory computer-readable tangible media that includes instructions for execution, which when executed by a processor of a computing device, is operable to perform operations comprising:
receiving a request to optimize an advertisement, wherein:
the request is received at one tier from another tier of a tiered software framework, and
the tiered software framework comprises a plurality of tiers differentiated by access management policies;
encoding in a latent space using a machine model, an embedding of the advertisement, the latent space comprising other embeddings of previously published advertisements having corresponding actual engagement rates;
identifying clusters in the latent space;
starting with the embedding of the advertisement, iteratively deriving an optimized embedding based at least on: (i) purposeful movements in the latent space towards selected ones of the clusters, and (ii) predicted engagement rates of candidate embeddings derived from the purposeful movements, wherein the purposeful movements are based at least on relative differences in engagement rates and respective distances of the selected clusters from candidate embeddings derived in preceding iterations;
generating a final advertisement from the optimized embedding, the final advertisement generated at the one tier; and
publishing the final advertisement at the another tier.

9. The non-transitory computer-readable tangible media of claim 8, wherein iteratively deriving the optimized embedding comprises:
setting the embedding as a first embedding;
predicting a first engagement rate of the first advertisement;
executing a sequence of steps, each purposeful movement comprising one sequence, the sequence comprising:
calculating, for each cluster: (i) a distance between the first embedding and a centroid of the cluster, (ii) a difference in the first engagement rate and an average engagement rate of the cluster, and (iii) a gradient as a ratio of the difference to the distance;
selecting one of the clusters having a larger gradient than other clusters;
modifying the first embedding into a second embedding according to attributes of the selected cluster;
predicting a second engagement rate of the second embedding; and
responsive to determining that the second engagement rate is less than at least one of: (i) the first engagement rate or (ii) a predetermined engagement rate threshold: resetting the second embedding as the first embedding, and resetting the second engagement rate as the first engagement rate; and
repeatedly executing the sequence of steps until the second engagement rate is not less than at least one of: (i) the first engagement rate or (ii) the predetermined engagement rate threshold.

10. The non-transitory computer-readable tangible media of claim 9, wherein modifying the first embedding comprises altering parameter values in the first embedding by a scale factor proportional to the gradient calculated for the selected cluster.

11. The non-transitory computer-readable tangible media of claim 9, wherein:
the first advertisement in the request comprises an original image,
the operations further comprise, in each sequence of steps:
decoding the second embedding into a second advertisement; and
calculating a similarity metric between a generated image in the second advertisement and the original image, and
resetting the second embedding, and the second engagement rate is responsive further to determining that the similarity metric is below a predetermined similarity threshold.

12. The non-transitory computer-readable tangible media of claim 8, wherein:
the request originates from an account at the another tier of the tiered software framework,
the another tier comprises multiple accounts, and
the access management policies specify that data from the one tier is not accessible at the another tier, data from the another tier is accessible at the one tier, and data in one account is not accessible by another account.

13. The non-transitory computer-readable tangible media of claim 12, wherein the previously published advertisements are associated with different accounts at the another tier.

14. The non-transitory computer-readable tangible media of claim 8, wherein the engagement rate comprises click-through-rate (CTR).

15. An apparatus comprising:
a processing circuitry;
a memory storing data; and
a communication circuitry, wherein the processing circuitry executes instructions associated with the data, the processing circuitry is coupled to the communication circuitry and the memory, and the processing circuitry and the memory cooperate, such that the apparatus is configured for:
receiving a request to optimize an advertisement, wherein:
the request is received at one tier from another tier of a tiered software framework, and
the tiered software framework comprises a plurality of tiers differentiated by access management policies;
encoding in a latent space using a machine model, an embedding of the advertisement, the latent space comprising other embeddings of previously published advertisements having corresponding actual engagement rates;
identifying clusters in the latent space;
starting with the embedding of the advertisement, iteratively deriving an optimized embedding based at least on: (i) purposeful movements in the latent space towards selected ones of the clusters, and (ii) predicted engagement rates of candidate embeddings derived from the purposeful movements, wherein the purposeful movements are based at least on relative differences in engagement rates and respective distances of the selected clusters from candidate embeddings derived in preceding iterations;
generating a final advertisement from the optimized embedding, the final advertisement generated at the one tier; and
publishing the final advertisement at the another tier.

16. The apparatus of claim 15, wherein iteratively deriving the optimized embedding comprises:
setting the embedding as a first embedding;
predicting a first engagement rate of the first advertisement;
executing a sequence of steps, each purposeful movement comprising one sequence, the sequence comprising:
calculating, for each cluster: (i) a distance between the first embedding and a centroid of the cluster, (ii) a difference in the first engagement rate and an average engagement rate of the cluster, and (iii) a gradient as a ratio of the difference to the distance;
selecting one of the clusters having a larger gradient than other clusters;
modifying the first embedding into a second embedding according to attributes of the selected cluster;
predicting a second engagement rate of the second embedding; and
responsive to determining that the second engagement rate is less than at least one of: (i) the first engagement rate or (ii) a predetermined engagement rate threshold: resetting the second embedding as the first embedding, and resetting the second engagement rate as the first engagement rate; and
repeatedly executing the sequence of steps until the second engagement rate is not less than at least one of: (i) the first engagement rate or (ii) the predetermined engagement rate threshold.

17. The apparatus of claim 16, wherein modifying the first embedding comprises altering parameter values in the first embedding by a scale factor proportional to the gradient calculated for the selected cluster.

18. The apparatus of claim 16, wherein:
the first advertisement in the request comprises an original image,
the apparatus is further configured for: in each sequence of steps:
decoding the second embedding into a second advertisement; and
calculating a similarity metric between a generated image in the second advertisement and the original image, and
resetting the second embedding, and the second engagement rate is responsive further to determining that the similarity metric is below a predetermined similarity threshold.

19. The apparatus of claim 15, wherein:
the request originates from an account at the another tier of the tiered software framework,
the another tier comprises multiple accounts, and
the access management policies specify that data from the one tier is not accessible at the another tier, data from the another tier is accessible at the one tier, and data in one account is not accessible by another account.

20. The apparatus of claim 19, wherein the previously published advertisements are associated with different accounts at the another tier.
